(19) United States
(12) Patent Application Publication
(10) Pub. No.: US 2016/0196231 A1
(43) Pub. Date: Jul. 7, 2016

(54) SYSTEM AND METHOD FOR BUS BANDWIDTH MANAGEMENT IN A SYSTEM ON A CHIP

(71) Applicant: QUALCOMM INCORPORATED, SAN DIEGO, CA (US)

(72) Inventors: NHON TOAI QUACH, SAN JOSE, CA (US); JEAN-MARIE QUOC DANH TRAN, SAN DIEGO, CA (US); NIKOLAI SCHLEGEL, DANVILLE, CA (US); JEAN-LOUIS TARDIEUX, SAN DIEGO, CA (US); BING XIAO, SAN JOSE, CA (US)

(21) Appl. No.: 14/591,749

(22) Filed: Jan. 7, 2015

(51) Int. Cl. G06F 13/40; G06F 11/30; G06F 11/34

(52) U.S. Cl. CPC G06F 13/4068; G06F 11/3409; G06F 11/3027

(57) ABSTRACT

Various embodiments of methods and systems for managing bus bandwidth allocation in a system on a chip are disclosed. Certain embodiments monitor a high speed bus for a measurement window of time to identify valid bits uniquely associated with transaction requests issued by a master processing engine. The method continues to monitor the bus over the window to identify completed transactions. A latency value is calculated by subtracting a target latency from an actual latency for each completed transaction. The latency value is aggregated in a counter. At the conclusion of the window, if the aggregated latency value is positive, the method may conclude that the average latency per transaction over the window exceeded the target latency per transaction and that the bandwidth allocated to the engine should be increased.

### DESCRIPTION OF THE RELATED ART

Portable computing devices (“PCDs”) are becoming necessities for people on personal and professional levels. These devices may include cellular telephones, tablets, portable digital assistants (“PDAs”), portable game consoles, palmtop computers, and other portable electronic devices. PCDs commonly contain integrated circuits, or systems on a chip (“SoC”), that include numerous components designed to work together to deliver functionality to a user. For example, a SoC may contain any number of master processing engines such as modems, central processing units (“CPUs”) made up of one or multiple cores, graphical processing units (“GPUs”), etc. that read and write data and instructions to and from memory components on the SoC. The data and instruction “reads” and “writes” may be collectively termed “transactions” and are transmitted between the devices via a collection of wires known as a bus.

Notably, a bus may be shared by many master processing engines, each of which vies for an allocation of the bus bandwidth in order to send transaction requests and receive the responses to those transaction requests. The latency associated with servicing a transaction sent from a master processing engine is often used to determine when a bus bandwidth allocation to that master processing engine should be increased or decreased. When the average latency of the transactions from a master processing engine exceeds a critical threshold (i.e., the latency is too long), data may be returned to the master processing engine at a faster rate than it can consume the same, thereby lowering the latency and causing its cache or latency buffer to fill. When the average latency of the transactions falls or stays below a threshold (i.e., the latency is shorter than is necessary to maintain an optimum quality of service level), data may be returned to the master processing engine at a slower rate, emptying the cache or the latency buffer.

In the prior case, the master processing engine raises the priority level of its transactions to attempt to refill the cache or the latency buffer. As such, an excessive lag in detection time for measuring average latency of transactions dictates that the cache or buffer size for a master processing engine be increased to avoid stalling the master processing engine. Larger caches or latency buffers are expensive as they consume valuable silicon area on the SoC. Therefore, there is a need in the art for a system and method that quickly detects when a master processing engine is not receiving an amount of expected bandwidth so that adjustments in priority level can be made by the master processing engine to ensure that a proper quality of service (“QoS”) level is maintained at or above a target level.

### SUMMARY OF THE DISCLOSURE

Various embodiments of methods and systems for managing bus bandwidth allocation in a system on a chip (“SoC”) are disclosed. Because latency buffers and tightly coupled memory devices to master processing engines take up valuable space on a chip and increase manufacturing costs, it may be desirable to minimize the need for large tightly coupled memory devices. Because one purpose of tightly coupled memory devices and latency buffers is to ensure that a master processing engine does not run out of workload while it waits for a transaction request to be answered, exemplary methods according to the solutions described herein seek to quickly recognize and respond to a need for adjusting bandwidth allocations. In this way, embodiments may reprioritize to a memory controller outstanding transaction requests such that QoS is maintained and the size of tightly coupled memory devices is optimized.

One exemplary method for managing bus bandwidth allocation in a SoC includes monitoring over a first measurement window a high speed bus to identify valid bits uniquely associated with transaction requests issued by a master processing engine. For each identified valid bit, each of a Total Valid Transaction Counter (“TVTC”) and a Running Valid Transaction Counter (“RVTC”) are incremented by one. The method continues to monitor the bus over the first measurement window to identify completed transactions. For each identified completed transaction, the RVTC is decremented and a latency value is added to a Total Latency Aggregator (“TLA”). The latency value is calculated by subtracting a target latency from an actual latency for the completed transaction. At the conclusion of the first measurement window, the method determines the sign of the TLA value. If the TLA value is positive, the method may conclude that the average latency per transaction over the window exceeded the target latency and that the bandwidth allocated to the engine should be increased; if the TLA value is negative, the method may conclude that the master processing engine could maintain its QoS with less bandwidth allocation. Based on the determinations, the method may work with a memory controller to optimize allocation of bus bandwidth by reprioritizing outstanding transactions associated with one or more master processing engines using the bus.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram illustrating an embodiment of an on-chip system for managing priorities of bus bandwidth allocations to master processing engines based on latency measurements associated with read/write transactions to a double data rate (“DDR”) memory;

FIG. 2 is a functional block diagram illustrating an exemplary, non-limiting aspect of a portable computing device (“PCD”) in the form of a wireless telephone for implementing methods and systems for managing priorities of bus bandwidth allocations to master processing engines based on latency measurements associated with read/write transactions to a double data rate (“DDR”) memory;

FIG. 3 illustrates calculation of a Total Valid Transaction Count (“TVTC”) and a Running Valid Transaction Count (“RVTC”) from a bus over a given measurement window;

FIG. 4 is a logical flowchart illustrating a method for managing priorities of bus bandwidth allocations to master processing engines based on latency measurements associated with read/write transactions to a double data rate (“DDR”) memory; and

FIG. 5 is a functional block diagram illustrating an exemplary embodiment of a bandwidth and latency manager (“BW&L”) module for managing priorities of bus bandwidth allocations to master processing engines based on latency measurements associated with read/write transactions transmitted over a high speed bus.

### DETAILED DESCRIPTION

The word “exemplary” is used herein to mean serving as an example, instance, or illustration. Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

In this description, reference to “DDR” memory components will be understood to envision any of a broader class of volatile random access memory (“RAM”) and will not limit the scope of the solutions disclosed herein to a specific type or generation of RAM. That is, it will be understood that various embodiments of the systems and methods provide a solution for managing bandwidth allocation based on monitoring of latencies associated read and/or write transaction requests to a memory component defined by pages/rows of memory banks and are not necessarily limited in application to double data rate memory. Moreover, it is envisioned that certain embodiments of the solutions disclosed herein may be applicable for managing priorities for transactions to DDR, DDR-2, DDR-3, low power DDR (“LPDDR”), graphics DDR (“GDDR”), magnetoresistive RAM (“MRAM”), spin-transfer torque RAM (“STTRAM”) or any subsequent generation of RAM.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used interchangeably. Moreover, a CPU, DSP, GPU or chip may be comprised of one or more distinct processing components generally referred to herein as “core(s).”

In this description, the terms “engine,” “processing engine,” “master processing engine” and the like are used to refer to any component within a system on a chip (“SoC”) that transfers data over a bus to or from a memory component. As such, a processing engine may refer to, but is not limited to refer to, a CPU, DSP, GPU, modem, controller, etc.

In this description, the term “bus” refers to a collection of wires through which data is transmitted from a processing engine to a memory controller or other device located on or off the SoC. It will be understood that a bus consists of two parts—an address bus and a data bus where the data bus transfers actual data and the address bus transfers information specifying location of the data in a memory component. The term “width” or “bus width” refers to an amount of data, i.e., a “chunk size,” that may be transmitted per cycle through a given bus. For example, a 16-byte bus may transmit 16 bytes of data at a time, whereas 32-byte bus may transmit 32 bytes of data per cycle. Moreover, “bus speed” refers to the number of times a chunk of data may be transmitted through a given bus each second. Similarly, a “bus cycle” or “cycle” refers to transmission of one chunk of data through a given bus in one clock cycle.

In this description, the terms “transaction” and “transaction request” are used interchangeably to refer to requests from a master processing engine, over a bus, to a memory controller to either read or write data or instructions to or from a memory storage device, such as a double data rate (“DDR”) memory. Consequently, the term “outstanding transaction” is used in this description to refer to a transaction request that has not yet been responded to by the memory controller, i.e., the memory controller has not fulfilled the request. The term “completed transaction” refers to a transaction request that has been responded to, i.e. the transaction request generated by the given master processing engine has been fulfilled.

In this description, the term “latency” refers to the amount of time required for a transaction request to be completed or fulfilled, as would be understood by one of ordinary skill in the art. The latency of a read transaction, for example, covers the time span starting with the master processing engine sending out the address on the bus and ending with the data returned by the memory controller to the requesting master processing engine.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

Various master processing engines running simultaneously in a PCD to deliver functionality to a user at a certain QoS level may necessitate that a bus of the PCD's SoC have a width sized to accommodate a large volume of data traffic. Simply speaking, with increased ability to deliver functionality comes the need for a data highway that can accommodate peak demand on the SoC for data transfer. Even so, it is common for transactions generated by one master processing engine to have to wait in a queue to be serviced while a memory controller accommodates a higher priority transaction emanating from a different master processing engine. Generally, the longer the latency for a given transaction to be serviced, the lower the bandwidth allocation to the master processing engine that generated the transaction. Similarly, the shorter the latency for receiving a return response to a transaction request, the higher the bandwidth priority which was afforded the transaction.

A memory controller, such as a dynamic random access memory (“DRAM”) memory controller, may marshal the transactions to and from a DRAM memory device to service the read/write requests based on a number of considerations such as, but not limited to, arrival time of the requests for deadlock prevention, data consistency to avoid data corruption, and priority to improve response time and user experience. When the memory controller is servicing a transaction from one master processing engine, transactions generated by other master processing engines may have wait to be serviced thereby risking a stall of the master processing engines associated with them. This wait time for any given transaction may vary depending on the total processing load placed on the memory controller from the master processing engines in the system. To avoid this wait time and/or accommodate this wait time variation, cache memories and/or latency buffers are often used within the master processing engines so that an engine may continue processing a workload from its cache or buffer while waiting for data or a response to its transaction.

When the needed data is not in its cache, or when its buffer gets low, then the priority for servicing a transaction issued by the master processing engine may be increased in an effort to avoid stalling of the master processing engine—i.e., the bandwidth allocation to that master processing engine may be increased at the expense of a bandwidth allocation to a competing master processing engine. Otherwise, when the waiting master processing engine runs out of workload, it will stall and its Quality of Service (“QoS”) will suffer.

To manage the latencies associated with transaction requests so that processing engines avoid stalling and QoS levels remain optimized, it may be desirable to accurately calculate average latencies so that bandwidth allocations may be adjusted in view of the calculations. Outstanding transactions, i.e., transactions which have been issued by master processing engines but have not been serviced, may be tracked. The more transactions that are tracked over a given measurement window, the more accurate a calculation for average latency per completed transaction may be. For example, suppose a memory latency is 100 nanoseconds and a single transaction is serviced during that period—the latency for that single transaction would be 100 nanoseconds. However, if four transactions were issued and serviced over that 100 nanoseconds, then the average latency per transaction would be 25 nanoseconds. Consequently, and as one of ordinary skill in the art would recognize, the ability to monitor overlapping transactions in a measurement window lends itself to a more accurate average latency calculation.

Recognizing the need to monitor overlapping transactions in order to accurately determine average latency per transaction, current solutions known in the art require as many counters as there may be simultaneous transactions generated by a master processing engine. Current solutions also require a divider component in order to calculate the average latency from the sum of all latencies tallied by the dedicated counters. Dedicated counters per transaction and divider components are not only expensive, but may require additional amounts of silicon area within a PCD. And one master may issue multiple types of traffic streams, requiring multiple sets of monitoring logic. It is therefore important to optimize the efficiency of the monitoring logic.

Notably some current solutions avoid the expense and area of a divider and numerous dedicated counters by using only a single counter that samples a number of transactions. Because the single counter solution is incapable of tracking overlapping transactions, the accuracy of any calculated average latency resulting from a single counter solution may be inaccurate. Additionally, to avoid the area cost of a divider, single counter solutions known in the art must always sample a number of transactions that is a power of 2 so that the division operation to calculate average latency becomes a simple right shift operation. Notably, because a sample size over a given measurement window may not be a power of two (“2”), single counter solutions known in the art may require the measurement window to be extended to reach the desired transaction count. Extending the measurement window results in an extension of detection time to determine the average latency. The lengthened detection time may make it difficult to detect low bandwidth allocations, resulting in a need to increase the size of the cache or latency buffer.

Advantageously, embodiments of the bandwidth management solutions described in the present disclosure generate an accurate average latency measurement/calculation 1) without needing a large number of counters, and 2) without using a divider. Additionally, embodiments of the bandwidth management solutions described in the present disclosure provide for using low speed hardware logic residing in a low fixed frequency domain to compute average latencies and adjust bandwidth priorities based on tracked transactions that are arriving on a high speed bus in a variable frequency domain. Embodiments of the solutions accommodate the synchronization differences between the bus domain and the logic domain by using shift registers in lieu of cascaded flip flops or the like. Instead of monitoring transactions, embodiments of the bandwidth management solutions “sniff” the high speed bus for valid bits and check the associated address to conclude that a valid transaction was issued by the master processing engine.

Instead of using a counter per transaction, embodiments of the solution count the number of valid bits arriving on the bus in each cycle. For example, if there are six outstanding transactions (i.e., transactions which have arrived on the bus but have not been answered by the memory controller), embodiments count the number of valid bits in both a Total Valid Transaction Count (“TVTC”) register and Running Valid Transaction Count (“RVTC”) register. For each transaction that is completed during the measurement window, the RVTC counter is decremented and a Total Latency Accumulator (“TLA”) is increased by a latency associated with the completed transaction. Notably, the latency may be quantified in units of clock cycles, nanoseconds or any other unit of time useful for the particular application. At the end of the measurement window, TLA may be divided by TVTC to obtain the average latency per transaction.

To avoid the need for a divider, embodiments of the bandwidth management solutions may use a pair of registers, register “MATC” and register “TL”, that are software programmable. The MATC register may contain a value representative of the minimum number of transactions that must be monitored over a measurement window in order for a latency/bandwidth calculation to be considered accurate and reliable. The TL register may contain the target latency, or minimum latency threshold, for a transaction in order for the QoS associated with a given master processing engine to remain at a desired level. Consequently, the minimum average bandwidth needed to maintain a QoS level may be calculated as: Min_Average_BW=MATC*Transaction_Burst_Size/TL.

When certain embodiments of the solution recognize a valid transaction on the bus, the RVTC and TVTC counters are incremented by one. Upon completion of the transaction, the RVTC counter is decremented. In this way, the value of the RVTC counter represents the number of outstanding transactions at any given clock cycle. When the RVTC counter is decremented, the TL is subtracted from the TLA (notably, the actual latency of the completed transaction was added to the TLA). At the end of a measurement window, if TVTC>MATC, then the sample size of transactions during the measurement window was sufficiently large to generate a reliable average latency calculation.

Next, the sign of the TLA may then be checked. Notably, because for each completed transaction its actual latency size was added to the TLA while the target latency (“TL”) size was subtracted, the TLA represents an aggregate of the “deltas” between the actual latency per transaction and the target latency per transaction. Consequently, a positive TLA indicates that the actual average latency was longer per transaction than the target latency (thereby indicating that additional bandwidth should be allocated to the master processing engine in order to maintain a suitable QoS). Similarly, a negative TLA indicates that the actual average latency was shorter per transaction that the target latency (thereby indicating that transactions emanating from the given master processing engine may be deprioritized in favor of allocating bandwidth to transactions associated with other master processing engines on the bus). In this way, it is an advantage of embodiments of the solution that the above determination may be made without using a divider component to calculate the average latency per transaction.

To obtain the average bandwidth (“BW”), software may read out the values of TVTC and TLA at the end of a measurement window. Because the TLA is an aggregate of the deltas, each calculated as the actual latency per transaction minus the target latency per transaction, the Total Adjusted Latency (“Adjusted_TLA”)=(TVTC*MATC)+TLA. The Average Latency per transaction=Adjusted_TLA/TVTC. And, the Average BW=(TVTC*Burst_size)/Adjusted_TLA.

Repeating the steps of the exemplary embodiment outlined above, software may be used to apply the equation Min_BW_Threshold=(MATC*Burst_Size)/TL in order to calculate values to program into the MATC and TL registers. Hardware is used to sniff the valid bits on the bus and filter out the unwanted ones. As the valid bits are sniffed out, the filtered valid bits may be shifted into shift registers in a round robin fashion. The total number of valid transactions issued over the measurement window may be counted by incrementing the Total Valid Transaction Count (“TVTC”) register and the Running Valid Transaction Count (“RVTC”) register. For each cycle, the actual latency for each completed transaction (and optionally fix up amount) is added to the TLA counter. When there is a data response and TID match, one of the valid bits is cleared, the RVTC is decremented, and the TL is subtracted from the TLA counter. Consequently, at the end of a measurement window, if TVTC>MATC and TLA is positive (MSB=0), the hardware may generate a trigger to adjust bandwidth allocation/priority for transactions associated with the given master engine. Otherwise, bandwidth may be allocated to other master processing engines in an effort to optimize QoS across the SoC.

Notably, and as one of ordinary skill in the art would recognize, an implementation of an embodiment of the solution may monitor as many data streams as needed by adding more threshold registers and valid bit accumulation logic blocks.

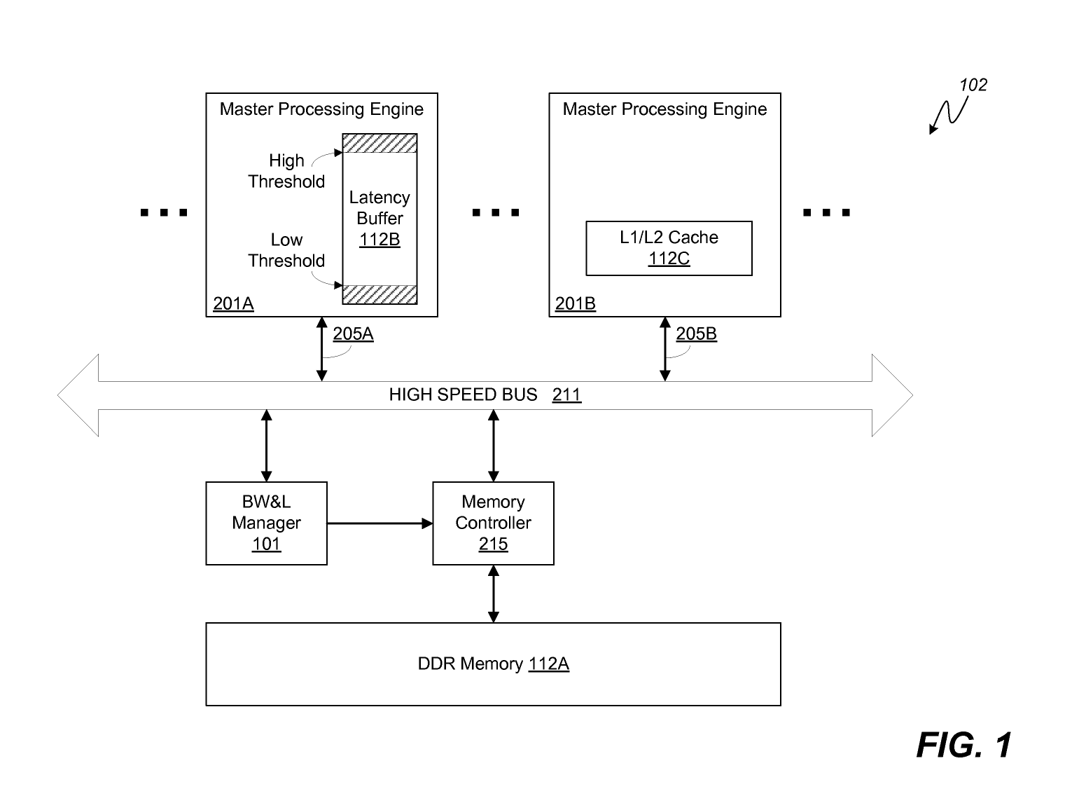

Turning now to the figures, FIG. 1 is a functional block diagram illustrating an embodiment of an on-chip system 102 for managing priorities of bus 211 bandwidth allocations to master processing engines 201 based on latency measurements associated with read/write transactions to a double data rate (“DDR”) memory 112A. As indicated by the arrows 205 in the FIG. 1 illustration, a processing engine 201 may be submitting transaction requests for either reading data from the DDR 112A or writing data to the DDR 112A, or a combination thereof, via a system bus 211. As is understood by one of ordinary skill in the art, a processing engine 201, such as the CPU 110, in executing a workload could be fetching and/or updating instructions and/or data that are stored at the address(es) of the DDR memory 112A. Notably, the exemplary embodiment of FIG. 1 is described within the context of transmitting data to a DDR memory 112A via a memory controller 215, however, this is for illustrative purposes only as one of ordinary skill in the art would recognize that alternative embodiments of the solutions disclosed herein may facilitate transfer of data from processing engines on a SoC via a main bus to any other device on the SoC and/or any other memory component type.

Returning to the FIG. 1 illustration, two exemplary master processing engines 201 are depicted. Both engines 201 are uniquely associated with exemplary tightly coupled memories 112. The master processing engine 201A is shown associated with a latency buffer 112B having a “high threshold” and a “low threshold.” The master processing engine 201B is shown associated with an L1/L2 cache 112C. As would be understood by one of ordinary skill in the art, the master processing engine 201B may fetch and write instructions and data to and from its cache 112C unless and until the cache 112C is determined not to contain an up to date image (at which point a transaction request may be issued by the engine 201B to the memory controller 215).

As would be understood by one of ordinary skill in the art, the master processing engine 201A may continue to process workload buffered in the latency buffer 112B while it waits for a response to a previously generated transaction request. Because other processing engines 201 utilizing bus 211 may have a higher priority status with the memory controller 215 at any given time than does processing engine 201A, the latency for receiving a response to a transaction request may vary. Consequently, the latency buffer 112B must be sized large enough to hold workload sufficient to avoid the risk that the processing engine 201A may stall for lack of workload while it waits for a response to its outstanding transaction request. When the workload queued in the latency buffer 112B nears or reaches the low threshold, the priority of any outstanding transaction request must be raised with the memory controller if the processing engine 201A is to avoid stalling. By contrast, when the workload queued in the latency buffer 112B nears or exceeds the high threshold, the priority of any outstanding transaction request from the master processing engine 201A may be downgraded in priority so that more urgent transaction requests from other master processing components 201 may be promptly serviced by the memory controller 215.

As one of ordinary skill in the art would understand, the quality of service (“QoS”) associated with a given processing component may be directly correlated with the speed at which the processing component is capable of processing workload. Consequently, if a processing component runs out of workload while it is waiting for a transaction request to be serviced, the QoS suffers. Advantageously, embodiments of a bandwidth and latency manager (“BW&L”) module 101 provide for monitoring the latencies associated with servicing of transaction requests. With latencies recognized and analyzed in view of target latencies needed to maintain a satisfactory QoS level, embodiments of the solution may be able to modulate the priority of outstanding transaction requests such that the given processing engines 201 avoid stalling for lack of workload.

The BW&L manager 101 “sniffs” valid packets on the bus 211 that are associated with issued and, therefore outstanding, transaction requests. The BW&L manager 101 also recognizes tag IDs (“TIDs”) on the bus indicative of a completed transaction. By aggregating the data to ensure accuracy of calculations for average latency trends, the BW&L manager 101 may make near real time decisions on bandwidth allocations needed to maintain suitable QoS levels for each of the master processing engines 201. The BW&L manager 101 may respond with alerts or triggers to adjust the priority of certain outstanding transactions with the memory controller 115. In doing so, the BW&L manager 101 may drive the actual average latencies associated with outstanding transactions toward a target latency per transaction that optimizes QoS.

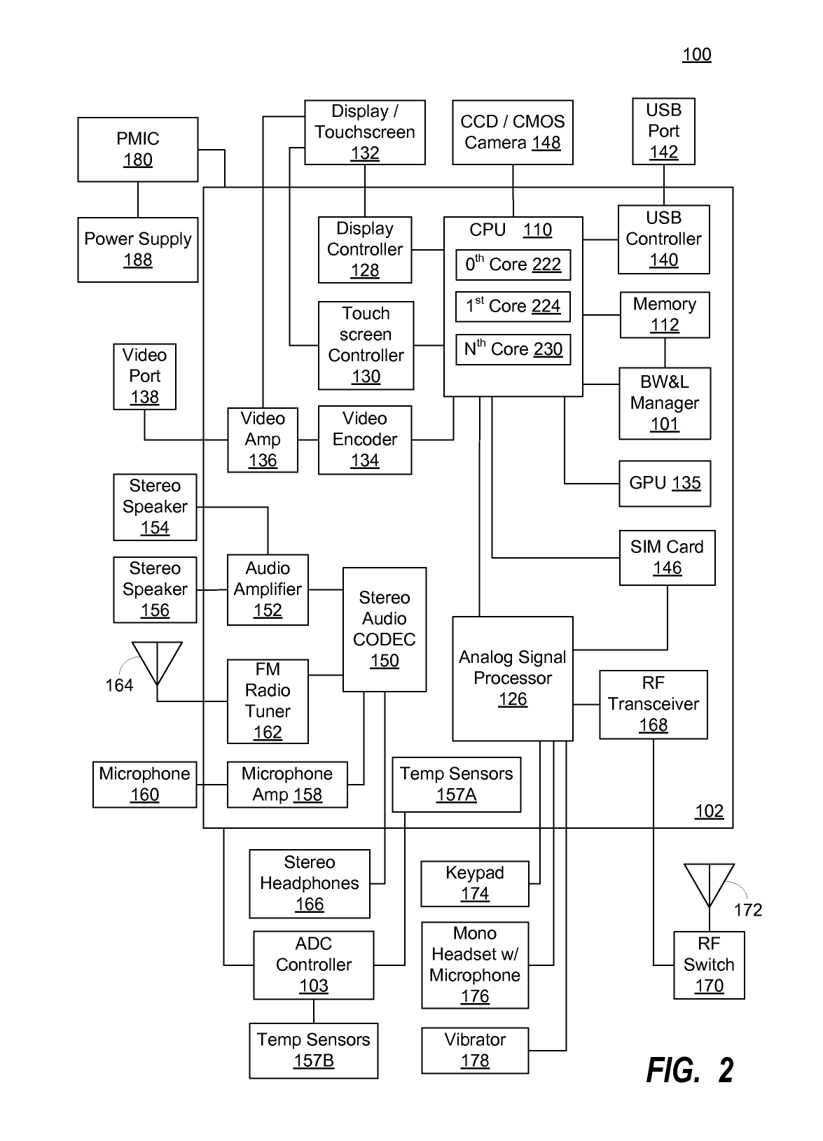

FIG. 2 is a functional block diagram illustrating an exemplary, non-limiting aspect of a portable computing device (“PCD”) 100 in the form of a wireless telephone for implementing methods and systems for managing priorities of bus bandwidth allocations to master processing engines based on latency measurements associated with read/write transactions to a double data rate (“DDR”) memory 112A. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, bandwidth and latency (“BW&L”) manager 101 may be formed from hardware and/or firmware and may be responsible monitoring transactions on a bus, determining latencies and triggering adjustments of bandwidth allocations in order to maintain desired QoS levels for master processing engines using the bus. It is envisioned that write bursts and read requests to a DDR memory 112A (generally labeled 112 in the FIG. 2 illustration), for instance, may be delayed due to bandwidth constraints on a bus shared by multiple master processing engines. The delay in servicing a request may not affect a master processing engine's QoS unless and until the engine completes all workloads queued in a tightly coupled memory, such as a cache or a latency buffer. In order to minimize tightly coupled memory sizes without running the risk that lower priority transactions become high priority as queued workloads are depleted, a BW&L module may monitor transaction latencies, compare them to target latencies and then work with a memory controller to adjust transaction priorities among a plurality of master processing engines.

As illustrated in FIG. 2, a display controller 128 and a touch screen controller 130 are coupled to the digital signal processor 110. A touch screen display 132 external to the on-chip system 102 is coupled to the display controller 128 and the touch screen controller 130. PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core CPU 110. A video amplifier 136 is coupled to the video encoder 134 and the touch screen display 132. A video port 138 is coupled to the video amplifier 136. As depicted in FIG. 2, a universal serial bus (“USB”) controller 140 is coupled to the CPU 110. Also, a USB port 142 is coupled to the USB controller 140. A memory 112, which may include a PoP memory, a cache, a mask ROM/Boot ROM, a boot OTP memory, a DDR memory, etc. may also be coupled to the CPU 110. A subscriber identity module (“SIM”) card 146 may also be coupled to the CPU 110. Further, as shown in FIG. 2, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 2, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 2 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 2 further indicates that a radio frequency (“RF”) transceiver 168 may be coupled to the analog signal processor 126. An RF switch 170 may be coupled to the RF transceiver 168 and an RF antenna 172. As shown in FIG. 2, a keypad 174 may be coupled to the analog signal processor 126. Also, a mono headset with a microphone 176 may be coupled to the analog signal processor 126. Further, a vibrator device 178 may be coupled to the analog signal processor 126. FIG. 2 also shows that a power supply 188, for example a battery, is coupled to the on-chip system 102 through a power management integrated circuit (“PMIC”) 180. In a particular aspect, the power supply 188 includes a rechargeable DC battery or a DC power supply that is derived from an alternating current (“AC”) to DC transformer that is connected to an AC power source.

The CPU 110 may also be coupled to one or more internal, on-chip thermal sensors 157A as well as one or more external, off-chip thermal sensors 157B. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller (not shown). However, other types of thermal sensors 157 may be employed.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, the PMIC 180 and the power supply 188 are external to the on-chip system 102. It will be understood, however, that one or more of these devices depicted as external to the on-chip system 102 in the exemplary embodiment of a PCD 100 in FIG. 2 may reside on chip 102 in other exemplary embodiments.

In a particular aspect, one or more of the method steps described herein may be implemented by executable instructions and parameters stored in the memory 112 or as form the BW&L manager 101. Further, the BW&L manager 101, the memory 112, the instructions stored therein, or a combination thereof may serve as a means for performing one or more of the method steps described herein.

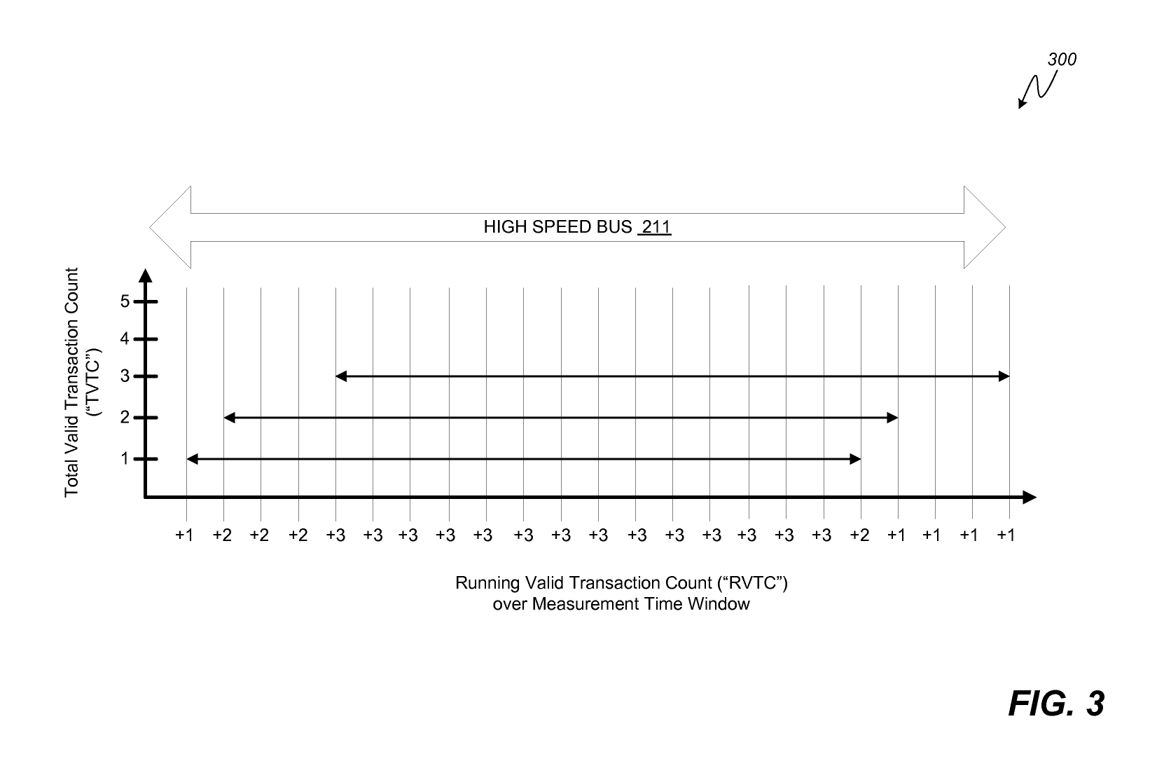

FIG. 3 illustrates calculation of a Total Valid Transaction Count (“TVTC”) and a Running Valid Transaction Count (“RVTC”) from a bus 211 over a given measurement window. In the illustration, the x-axis of the graph 300 is demarcated to depict successive clock cycles in an exemplary measurement window. The y-axis is demarcated to represent a cumulative number of transactions issued over the measurement window by a given master processing engine 201, such as engine 201A or engine 201B from the FIG. 1 illustration, for example. The exemplary measurement window opens at the intersection of the x-axis and the y-axis.

As can be seen from the FIG. 3 graph, as a first valid bit is sniffed on the bus by a BW&L manager 101, the TVTC and the RVTC are incremented to a value of one. As second and third valid bits are sniffed, the TVTC and RVTC counters are incremented to two and then three. As explained above, recognition of the valid bit as it transmits over the bus 211 indicates to the BW&L manager 101 that a transaction has been generated by the given processing engine 201 and is outstanding until completed.

As the BW&L manager sniffs bus 211 to recognize that the first outstanding transaction has been serviced by the memory controller, the RVTC is decremented by one to indicate that the number of outstanding transactions has been reduced. The TVTC remains at three. As each outstanding transaction is completed, the BW&L manager 101 may continue to decrement RVTC by one each time. Notably, at the end of the measurement window, the TVTC will indicate the total number of transactions issued by the given processing engine 201 over the measurement window; the RVTC will indicate the number of outstanding transactions issued during the measurement window but not yet serviced by the end of the measurement window. Notably, because the BW&L manager 101 may be able to determine the number of clock cycles it took for a certain transaction to be completed, it may also be able to determine the latency for completing the transaction.

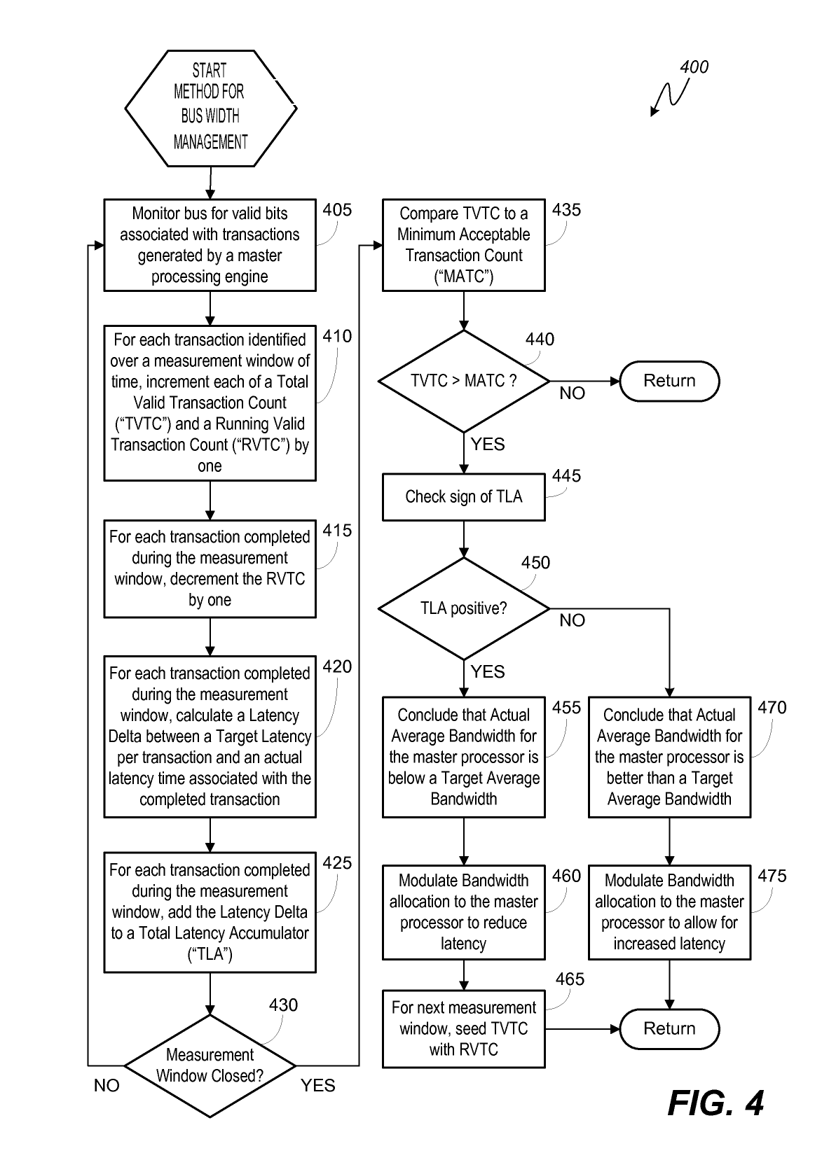

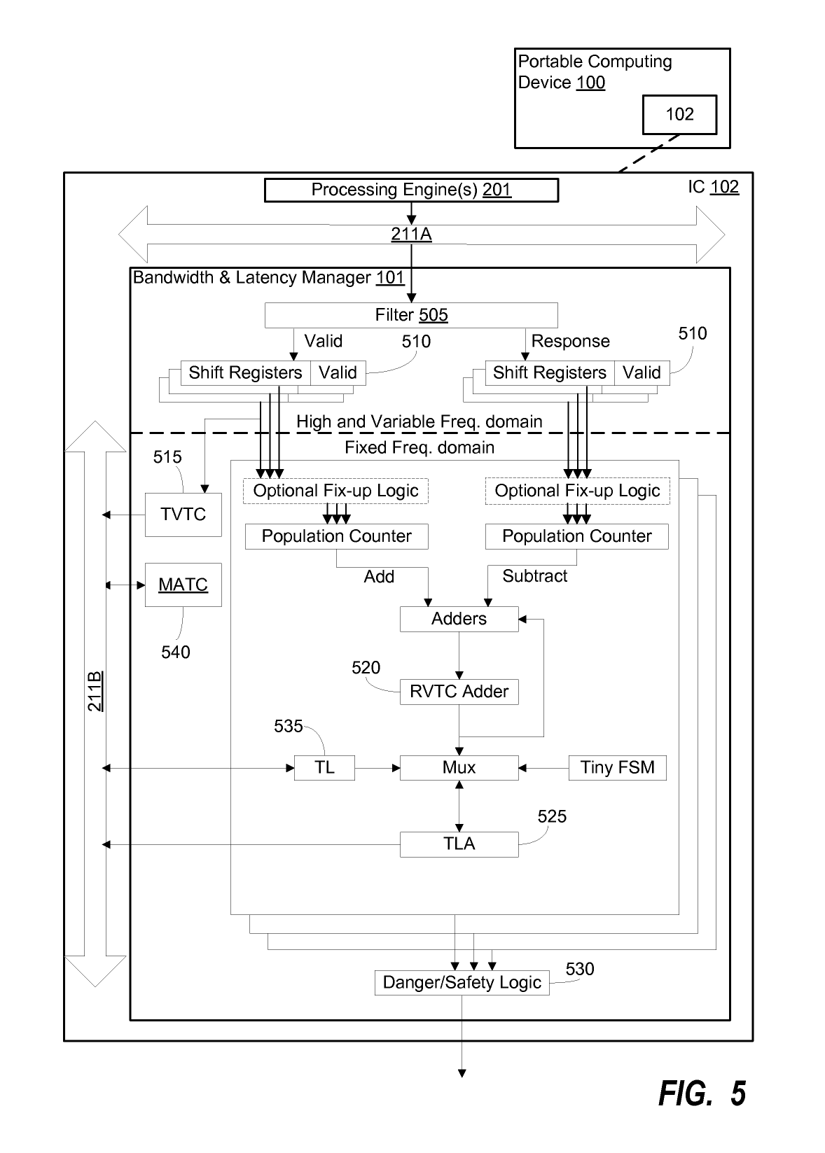

FIG. 4 is a logical flowchart illustrating a method 400 for managing priorities of bus bandwidth allocations to master processing engines 201 based on latency measurements associated with read/write transactions to a double data rate (“DDR”) memory 112A. Beginning at block 405, the BW&L manager 101 may monitor the bus 211 to recognize valid bits indicative of issued, and therefore outstanding, transaction requests from a master processing engine 201. At block 410, the TVTC counter 515 (shown in FIG. 5) and the RVTC counter 520 (shown in FIG. 5) are incremented by one each time an outstanding transaction request is identified (as described above relative to the FIG. 3 illustration). Advantageously, embodiments of the solution proposed herein may be able to recognize and track multiple transaction requests generated and issued in parallel by a processing engine 201.

At block 415, for each transaction request that is completed during the measurement window, the RVTC counter 520 is decremented. At blocks 420 and 425, a Total Latency Accumulator 525 (shown in FIG. 5) is adjusted by a latency delta amount that represents the difference between the actual latency for the completed transaction (as determined by the BW&L manager 101) and a target latency (“TL”) 535 required in order for the given master processing engine 201 to maintain a satisfactory QoS. Notably, it is envisioned that some embodiments may adjust the TLA 525 by first adding the actual latency of the completed transaction to the TLA and then subtracting from the TLA 525 the TL 535. Other embodiments, may calculate the latency delta and then add the latency delta to the TLA 525.

Returning to the method 400, at decision block 430 if the measurement window remains open then the method 400 loops back through blocks 405-425, monitoring and tracking outstanding and completed transactions. Once the measurement window closes, the method 400 advances to block 435 and the value in the TVTC counter 515 is compared to a value stored in a minimum acceptable transaction count (“MATC”) register 540 (shown in FIG. 5). The MATC value is a predetermined value indicating the minimum number of transactions that must be monitored in a given measurement window in order for any latency/bandwidth calculation resulting therefrom to be considered accurate and reliable. A decision block 440, if the TVTC does not equal or exceed the MATC value, then the “no” branch is followed and the method 400 returns. If the TVTC value does equal or exceed the MATC value, then the method 400 follows the “yes” branch to block 445.

At block 445 the sign of the value stored in the TLA 525 is checked. If the value is positive, BW&L manager 101 concludes at block 455 that the average latency per transaction over the measurement window exceeded the target latency. Next, at block 460 the BW&L manager 101 may work with the memory controller 115 to modulate the priority of outstanding transactions associated with the given master processing engine 201, thereby reducing the latency through an increased bandwidth allocation.

Returning to decision block 450, if the sign of the value stored in the TLA counter 525 is negative, then the “no” branch is followed to block 470. At block 470, the BW&L manager 101 concludes that the average latency per transaction over the measurement window was better than required in order to maintain a satisfactory QoS. Consequently, at block 475 the BW&L manager 101 may work with the memory controller 115 to reduce the average bandwidth allocation to the given master processing engine 201 in favor of prioritizing more urgent requests generated by other processing engines 201.

At the end of the measurement window, whether TLA is positive or negative, the method 400 may advance to block 465 and seed the RVTC counter 520 and the TVTC counter 515 to begin the next measurement window. It is envisioned that the RVTC counter 520 value at the end of the first measurement window may be either “zeroed out” or carried over to begin the next measurement window. If the RVTC counter 520 value is “zeroed out” then the TVTC counter 515 may also be reset to zero to begin the next window. If the value in the RVTC counter 520 at the end of a cycle is carried over to begin the next cycle, then the TVTC counter 515 may be seeded with the same value. Notably, for embodiments that reset both the RVTC counter 520 and the TVTC counter 515 at the beginning of a new measurement window, accuracy of any latency calculation resulting from the window may suffer slightly due to outstanding transactions existing at the beginning of the window, and completed during the window, not being represented in either the TVTC counter 515 or the RVTC counter 520.

Advantageously, by checking the sign of the TLA 525 value to evaluate latency, embodiments of the systems and methods disclosed herein avoid having to include a divider component within the BW&L manager 101. After block 465, the method 400 returns.

FIG. 5 is a functional block diagram illustrating an exemplary embodiment of a bandwidth and latency manager (“BW&L”) module 101 for managing priorities of bus bandwidth allocations to master processing engines 201 based on latency measurements associated with read/write transactions transmitted over a high speed bus 211A. As described above, the BW&L manager 101 sniffs a high speed bus 211A to recognize valid bits of outstanding transactions generated by a processing engine 201. The BW&L also recognizes when an outstanding transaction is completed and, using the measured number of clock cycles in order for the transaction to be completed, calculates a latency time. Based on the latency time, the BW&L manager 101 determines optimum bandwidth allocations needed to maintain a satisfactory QoS and works with a memory controller to adjust the priority level (and therefore the bandwidth allocation) of transactions generated by the master processing components 201. The outputs of the BW&L manager 101 may be passed out over an interprocessor bus 211B to the memory controller and other clocks, as would be understood by one of ordinary skill in the art.

Notably, because the high speed bus 211A may reside in a high speed and variable frequency domain while the BW&L logic resides in a lower speed, fixed frequency domain (to save power consumption), synchronization of the clocks may be required in order for the BW&L manager 101 to make accurate measurements.

Transaction requests may be transmitted over the bus 211A at a much higher frequency than the counting logic which resides in the lower frequency domain. Accordingly, in lieu of a flip flop or FIFO arrangement, exemplary BW&L module 101 embodiments may leverage three shift registers, each with a valid bit to rate match the valid bit. The valid bit is shifted into one of the three shift registers 510. At the beginning of the shift, the valid bit is cleared. At the end of the shift, the valid bit is set.

Advantageously, by using the three shift register arrangement, there may always be a valid clock edge. Notably, a correct number and length of the shift registers 510 between the bus 211A and the counting logic in the fixed frequency domain may be present regardless of the frequency ratio between the domains.

It is envisioned that a few slow clock cycles in the fixed frequency domain may be required in order for the valid bit to be synchronized. During such “synch up” time, certain BW&L manager 101 embodiments may not increment the TVTC counter 215 so as to mitigate inaccuracy. Advantageously, shift register based synchronization may allow for a “fix up” to enhance the accuracy of measurements. To do so, each bit in the shift register may be given a different weight when added to the total count.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Therefore, although selected aspects have been illustrated and described in detail, it will be understood that various substitutions and alterations may be made therein without departing from the spirit and scope of the present invention, as defined by the following claims.

What is claimed is:

1. A method for managing bus bandwidth allocation in a system on a chip (“SoC”), the method comprising:
monitoring over a first measurement window a bus to identify valid bits uniquely associated with transaction requests issued by a master processing engine;
for each identified valid bit, incrementing each of a Total Valid Transaction Counter (“TVTC”) and a Running Valid Transaction Counter (“RVTC”) by one;
monitoring over the first measurement window the bus to identify completed transactions;
for each identified completed transaction, decrementing the RVTC and adding a latency value to a Total Latency Aggregator (“TLA”) value, wherein the latency value is calculated by subtracting a target latency from an actual latency for a given completed transaction;
at the conclusion of the first measurement window, determining the sign of the TLA value;
increasing a bandwidth allocation to the master processing engine if the TLA value is positive; and
decreasing a bandwidth allocation to the master processing engine if the TLA value is negative.

2. The method of claim 1, further comprising:
at the conclusion of the measurement window, comparing the TVTC value to a Minimum Acceptable Transaction Count (“MATC”) value, wherein if the TVTC exceeds the MATC the TLA value is deemed reliable for making bandwidth allocation determinations.

3. The method of claim 1, wherein increasing the bandwidth allocation to the master processing engine comprises raising a priority to a memory controller for one or more outstanding transactions associated with the master processing engine.

4. The method of claim 1, wherein:
the bus resides in a variable frequency domain and the TVTC, RVTC and TLA reside in a fixed frequency domain; and
rates for each of the variable frequency domain and the fixed frequency domain are matched via multiple shift registers.

5. The method of claim 4, further comprising:
delaying incrementation of the TVTC counter at the beginning of the first measurement window, wherein delaying incrementation of the TVTC counter serves to synchronize the valid bit between a fixed frequency domain and a variable frequency domain.

6. The method of claim 1, further comprising:
monitoring over a second measurement window the bus to identify valid bits uniquely associated with transaction requests issued by the master processing engine;
setting the RVTC to a value selected from a group comprising:
the RVTC value at the conclusion of the first measurement window; and
zero;
setting the TVTC to the same value as the RVTC;
for each identified valid bit, incrementing each of the TVTC and the RVTC by one;
monitoring over the second measurement window the bus to identify completed transactions;
for each identified completed transaction, decrementing the RVTC and adding a latency value to the TLA, wherein the latency value is calculated by subtracting a target latency from an actual latency for a given completed transaction;
at the conclusion of the second measurement window, determining the sign of the TLA value;
increasing a bandwidth allocation to the master processing engine if the TLA value is positive; and
decreasing a bandwidth allocation to the master processing engine if the TLA value is negative.

7. The method of claim 1, wherein the SoC is comprised within a mobile telephone.

8. A system for managing bus bandwidth allocation in a system on a chip (“SoC”), the system comprising:
a bandwidth and latency (“BW&L”) manager operable to:
monitor over a first measurement window a bus to identify valid bits uniquely associated with transaction requests issued by a master processing engine;
for each identified valid bit, increment each of a Total Valid Transaction Counter (“TVTC”) and a Running Valid Transaction Counter (“RVTC”) by one;
monitor over the first measurement window the bus to identify completed transactions;
for each identified completed transaction, decrement the RVTC and adding a latency value to a Total Latency Aggregator (“TLA”) value, wherein the latency value is calculated by subtracting a target latency from an actual latency for a given completed transaction;
at the conclusion of the first measurement window, determine the sign of the TLA value;
increasing a bandwidth allocation to the master processing engine if the TLA value is positive; and
decreasing a bandwidth allocation to the master processing engine if the TLA value is negative.

9. The system of claim 8, wherein the BW&L manager is further operable to:
at the conclusion of the measurement window, compare the TVTC value to a Minimum Acceptable Transaction Count (“MATC”) value, wherein if the TVTC exceeds the MATC the TLA value is deemed reliable for making bandwidth allocation determinations.

10. The system of claim 8, wherein increasing the bandwidth allocation to the master processing engine comprises raising a priority to a memory controller for one or more outstanding transactions associated with the master processing engine.

11. The system of claim 8, wherein:
the bus resides in a variable frequency domain and the TVTC, RVTC and TLA reside in a fixed frequency domain; and
rates for each of the variable frequency domain and the fixed frequency domain are matched via multiple shift registers.

12. The system of claim 11, further comprising:
delaying incrementation of the TVTC counter at the beginning of the first measurement window, wherein delaying incrementation of the TVTC counter serves to synchronize the valid bit between a fixed frequency domain and a variable frequency domain.

13. The system of claim 8, wherein the BW&L manager is further operable to:
monitor over a second measurement window the bus to identify valid bits uniquely associated with transaction requests issued by the master processing engine;
set the RVTC to a value selected from a group comprising:
the RVTC value at the conclusion of the first measurement window; and
zero;
set the TVTC to the same value as the RVTC;
for each identified valid bit, increment each of the TVTC and the RVTC by one;
monitor over the second measurement window the bus to identify completed transactions;
for each identified completed transaction, decrement the RVTC and add a latency value to the TLA, wherein the latency value is calculated by subtracting a target latency from an actual latency for a given completed transaction;
at the conclusion of the second measurement window, determine the sign of the TLA value;
increasing a bandwidth allocation to the master processing engine if the TLA value is positive; and
decreasing a bandwidth allocation to the master processing engine if the TLA value is negative.

14. The system of claim 8, wherein the SoC is comprised within a mobile telephone.

15. A system for managing bus bandwidth allocation in a system on a chip (“SoC”), the system comprising:
means for monitoring over a first measurement window a bus to identify valid bits uniquely associated with transaction requests issued by a master processing engine;
for each identified valid bit, means for incrementing each of a Total Valid Transaction Counter (“TVTC”) and a Running Valid Transaction Counter (“RVTC”) by one;
means for monitoring over the first measurement window the bus to identify completed transactions;
for each identified completed transaction, means for decrementing the RVTC and adding a latency value to a Total Latency Aggregator (“TLA”) value, wherein the latency value is calculated by subtracting a target latency from an actual latency for a given completed transaction;
at the conclusion of the first measurement window, means for determining the sign of the TLA value;
increasing a bandwidth allocation to the master processing engine if the TLA value is positive; and
decreasing a bandwidth allocation to the master processing engine if the TLA value is negative.

16. The system of claim 15, further comprising:
at the conclusion of the measurement window, means for comparing the TVTC value to a Minimum Acceptable Transaction Count (“MATC”) value, wherein if the TVTC exceeds the MATC the TLA value is deemed reliable for making bandwidth allocation determinations.

17. The system of claim 15, wherein increasing the bandwidth allocation to the master processing engine comprises raising a priority to a memory controller for one or more outstanding transactions associated with the master processing engine.

18. The system of claim 15, wherein:
the bus resides in a variable frequency domain and the TVTC, RVTC and TLA reside in a fixed frequency domain; and
rates for each of the variable frequency domain and the fixed frequency domain are matched via multiple shift registers.

19. The system of claim 18, further comprising:
delaying incrementation of the TVTC counter at the beginning of the first measurement window, wherein delaying incrementation of the TVTC counter serves to synchronize the valid bit between a fixed frequency domain and a variable frequency domain.

20. The system of claim 15, further comprising:
means for monitoring over a second measurement window the bus to identify valid bits uniquely associated with transaction requests issued by the master processing engine;
means for setting the RVTC to a value selected from a group comprising:
the RVTC value at the conclusion of the first measurement window; and
zero;
means for setting the TVTC to the same value as the RVTC;
for each identified valid bit, means for incrementing each of the TVTC and the RVTC by one;
means for monitoring over the second measurement window the bus to identify completed transactions;
for each identified completed transaction, means for decrementing the RVTC and adding a latency value to the TLA, wherein the latency value is calculated by subtracting a target latency from an actual latency for a given completed transaction;
at the conclusion of the second measurement window, means for determining the sign of the TLA value;
increasing a bandwidth allocation to the master processing engine if the TLA value is positive; and
decreasing a bandwidth allocation to the master processing engine if the TLA value is negative.
